(19) United States
(12) Patent Application Publication
(10) Pub. No.: US 2008/0016095 A1
(43) Pub. Date: Jan. 17, 2008

(54) Multi-Query Optimization of Window-Based Stream Queries

(75) Inventors: Sudeept Bhatnagar, Plainsboro, NJ (US); Samrat Ganguly, Monmouth Junction, NJ (US); Song Wang, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/776,857

(22) Filed: Jul. 12, 2007

Related U.S. Application Data
(60) Provisional application No. 60/807,220, filed on Jul. 13, 2006.

(51) Int. Cl. G06F 17/30

(52) U.S. Cl. 707/101; 707/E17.002

(57) ABSTRACT

A method for sharing window-based joins includes slicing window states of a join operator into smaller window slices, forming a chain of sliced window joins from the smaller window slices, and reducing by pipelining a number of the sliced window joins. The method further includes pushing selections down into chain of sliced window joins for computation sharing among queries with different window sizes. The chain buildup of the sliced window joins includes finding a chain of the sliced window joins with respect to one of memory usage or processing usage.

This application claims the benefit of U.S. Provisional Application No. 60/807,220, entitled “State-Slice: New Paradigm of Multi-Query Optimization of Window-Based Stream Queries”, filed on Jul. 13, 2006, the contents of which is incorporated by reference herein.

### BACKGROUND OF THE INVENTION

The present invention relates generally to data stream management systems and, more particularly, to sharing computations among multiple continuous queries, especially for the memory- and CPU-intensive window-based operations.

Modern stream applications such as sensor monitoring systems and publish/subscription services necessitate the handling of large numbers of continuous queries specified over high volume data streams. Efficient sharing of computations among multiple continuous queries, especially for the memory- and CPU-intensive window-based operations, is critical. A novel challenge in this scenario is to allow resource sharing among similar queries, even if they employ windows of different lengths. However, efficient sharing of window-based join operators has thus far been ignored in the literature. Various strategies for intra-operator scheduling for shared sliding window joins with different window sizes have been proposed. Using a cost analysis, the strategies are compared in terms of average response time and query throughput. The present invention focuses instead on how the memory and CPU cost for shared sliding window joins can be minimized. Intra-operator scheduling strategies that have been proposed can naturally be applied for inter-operator scheduling of the present invention's sliced joins. Load-shedding and spilling data to disk are alternate solutions for tackling continuous query processing with insufficient memory resources. Approximated query processing is another general direction for handling memory overflow. Different from these, the present invention minimizes the actual resources required by multiple queries for accurate processing. These other works are orthogonal to the present invention's teachings and can be applied together with the present state-slice sharing.

The problem of sharing the work between multiple queries is not new. For traditional relational databases, multiple-query optimization seeks to exhaustively find an optimal shared query plan. Recent work in this area provides heuristics for reducing the search space for the optimally shared query plan for a set of SQL queries. These works differ from the present invention which is directed to the computation sharing for window-based continuous queries. In contrast, the traditional SQL queries do not have window semantics. Other teachings in this area have highlighted the importance of computation sharing in continuous queries. The sharing solutions employed in existing systems, such as NiagaraCQ, CACQ and PSoup, focus on exploiting common subexpressions in queries. Their shared processing of joins simply ignores window constraints which are critical for window-based continuous queries.

1. Introduction. Recent years have witnessed a rapid increase of attention in data stream management systems (DSMS). Continuous query based applications involving a large number of concurrent queries over high volume data streams are emerging in a large variety of scientific and engineering domains. Examples of such applications include environmental monitoring systems that allow multiple continuous queries over sensor data streams, with each query issued for independent monitoring purposes. Another example is the publish-subscribe services that host a large number of subscriptions monitoring published information from data sources. Such systems often process a variety of continuous queries that are similar in flavor on the same input streams.

Processing each such compute-intensive query separately is inefficient and certainly not scalable to the huge number of queries encountered in these applications. One promising approach in the database literature to support large numbers of queries is computation sharing. Many papers have highlighted the importance of computation sharing in continuous queries. Previous work has focused primarily on sharing of filters with overlapping predicates, which are stateless and have simple semantics. However in practice, stateful operators such as joins and aggregations tend to dominate the usage of critical resources such as memory and CPU in a DSMS. These stateful operators tend to be bounded using window constraints on the otherwise infinite input streams. Efficient sharing of these stateful operators with possibly different window constraints thus becomes paramount, offering the promise of major reductions in resource consumption.

Compared to traditional multi-query optimization, one new challenge in the sharing of stateful operators comes from the preference of in-memory processing of stream queries. Frequent access to hard disk will be too slow when arrival rates are high. Any sharing blind to the window constraints might keep tuples unnecessarily long in the system. A carefully designed sharing paradigm beyond traditional sharing of common sub-expressions is thus needed.

The present invention is directed to solving the problem of sharing of window join operators across multiple continuous queries. The window constraints may vary according to the semantics of each query. The sharing solutions employed in existing streaming systems, such as NiagaraCQ, CACQ and PSoup, focus on exploiting common sub-expressions in queries, that is, they closely follow the traditional multi-query optimization strategies from relational technology. Their shared processing of joins ignores window constraints, even though windows clearly are critical for query semantics.

The intuitive sharing method for joins with different window sizes employs the join having the largest window among all given joins, and a routing operator which dispatches the joined result to each output. Such method suffers from significant shortcomings as shown using the motivation example below. The reason is two folds, (1) the per-tuple cost of routing results among multiple queries can be significant; and (2) the selection pull-up, see detailed discussions of selection pull-up and push-down below, for matching query plans may waste large amounts of memory and CPU resources.

Motivation Example: Consider the following two continuous queries in a sensor network expressed using an SQL-like language with window extension.

| | |
|---|---|
| Q1: | SELECT A.* FROM Temperature A, Humidity B |
| | WHERE A.LocationId=B.LocationId |
| | WINDOW 1 min |
| Q2: | SELECT A.* FROM Temperature A, Humidity B |
| | WHERE A.LocationId=B.LocationId AND |
| | A. Value>Threshold WINDOW 60 min |

The above two queries are examples that have applications in detecting anomalies and performance problems in large data center running multiple applications. Q₁ and Q₂ join the data streams coming from temperature and humidity sensors by their respective locations. The WINDOW clause indicates the size of the sliding windows of each query. The join operators in Q₁ and Q₂ are identical except for the filter condition and window constraints. The naive shared query plan will join the two streams first with the larger window constraint (60 min). The routing operator then splits the joined results and dispatches them to Q₁ and Q₂ respectively according to the tuples' timestamps and the filter. The routing step of the joined tuples may take a significant chunk of CPU time if the fanout of the routing operator is much greater than one. If the join selectivity is high, the situation may further escalate since such cost is a per-tuple cost on every joined result tuple. Further, the state of the shared join operator requires a huge amount of memory to hold the tuples in the larger window without any early filtering of the input tuples. Suppose the selectivity of the filter in Q₂ is 1%, a simple calculation reveals that the naive shared plan requires a state size that is 60 times larger than the state used by Q₁, or 100 times larger than the state used by Q₂ each by themselves. In the case of high volume data stream inputs, such wasteful memory consumption is unaffordable and renders inefficient computation sharing.

2. Preliminaries. A shared query plan capturing multi-queries is composed of operators in a directed acyclic graph (DAG). The input streams are unbounded sequences of tuples. Each tuple has an associated timestamp identifying its arrival time at the system. We assume that the timestamps of the tuples have a global ordering based on the system's clock.

Sliding windows are commonly used constraints to define the stateful operators. The size of a window constraint is specified using either a time interval (time-based) or a count on the number of tuples (count-based). In this application, the inventive sharing method is presented using time-based windows. However, the inventive techniques can be applied to count-based window constraints in the same way. The discussion of join conditions is simplified by using equijoin, while the inventive technique is applicable to any type of join condition.

The sliding window equijoin between streams A and B, with window sizes W₁ and W₂ respectively over the common attribute Cᵢ can be denoted as A[W₁]_{C}_{ᵢ} B[W₂]. The semantics for such sliding window joins are that the output of the join consists of all pairs of tuples a ε A, b ε B, such that a.Cᵢ=b.Cᵢ (we omit Cᵢ in the future and instead concentrate on the sliding window only) and at certain time t, both a ε A[W₁] and b ε B[W₂]. That is, either T_{b}−Tₐ<W₁ or Tₐ−T_{b}<W₂. Tₐ and T_{b} denote the timestamps of tuple a and b respectively in this paper. The timestamp assigned to the joined tuple is max(Tₐ,T_{b}). The execution steps for a newly arriving tuple of A are shown. Symmetric steps are followed for a B tuple.

| | |
|---|---|
| 1. | Cross-Purge: Discard expired tuples in window B[W₂] |
| 2. | Probe: Emit a [symbol] B[W₂] |
| 3. | Insert: Add a to window A[W₁] |

### Execution of Sliding-Window Join

For each join operator, the input stream tuples are processed in the order of their timestamps. Main memory is used for the states of the join operators (state memory) and queues between operators (queue memory).

3. Review of Strategies for Sharing Continuous Queries. Using the example queries Q₁ and Q₂, from motivation example above, with generalized window constraints, we review the existing strategies in the literature for sharing continuous queries. The diagram 10 of FIG. 1 shows the query plans for Q₁ and Q₂ without computation sharing. The states in each join operator hold the tuples in the window. We use σ_{A} to represent the selection operator on stream A.

For the following cost analysis, we use the notations of the system settings in Table 1 below. We define the selectivity of σ_{A} as:

$$\frac{number\_of \_outputs}{number\_of \_inputs} .$$

We define the join selectivity S as:

$$\frac{number\_of \_outputs}{number\_of \_outputs \_from \_Cartesian \_Product} .$$

We focus on state memory when calculating the memory usage. To estimate the CPU cost, we consider the cost for value comparison of two tuples and the timestamp comparison. We assume that comparisons are equally expensive and dominate the CPU cost. We thus use the count of comparisons per time unit as the metric for estimated CPU costs. In this application, we calculate the CPU cost using the nested-loop join algorithm. Calculation using the hash-based join algorithm can be done similarly using an adjusted cost model.

TABLE 1
System Settings Used

| Symbol | Explanation |
|---|---|
| λ_{A} | Arrival Rate of Stream A (Tuples/Sec.) |
| λ_{B} | Arrival Rate of Stream B (Tuples/Sec.) |
| W₁ | Window Size for Q₁ (Sec.) |
| W₂ | Window Size for Q₂ (Sec.) |
| Mₜ | Tuple Size (KB) |
| S_{σ} | Selectivity of σ_{A} |
| [symbol] | Join Selectivity |

### Without loss of generality, we let 0<W₁<W₂. For simplicity, in the following computation, we set λ_{A}=λ_{B}, denoted as λ. The analysis can be extended similarly for unbalanced input stream rates.

3.1. Naive Sharing with Selection Pull-up. The PullUp or Filtered PullUp approaches proposed for sharing continuous query plans containing joins and selections can be applied to the sharing of joins with different window sizes. That is, we need to introduce a router operator to dispatch the joined results to the respective query outputs. The intuition behind such sharing lies in that the answer of the join for Q₁ (with the smaller window) is contained in the join for Q₂ (with the larger window). The shared query plan for Q₁ and Q₂ is shown by the diagram 20 in FIG. 2.

By performing the sliding window join first with the larger window size among the queries Q₁ and Q₂, computation sharing is achieved. The router then checks the timestamps of each joined tuple with the window constraints of registered CQs and dispatches them correspondingly. The compare operation happens in the probing step of the join operator, the checking step of the router and the filtering step of the selection. We can calculate the state memory consumption Cₘ (m stands for memory) and the CPU cost Cₚ (p stands for processor) as:

$$\{ \begin{matrix}{C}_{m} = & 2 λ {W}_{2} {M}_{t} \\ {C}_{p} = & 2 {λ}^{2} {W}_{2} + 2 λ + 2 {λ}^{2} {W}_{2} S + 2 {λ}^{2} {W}_{2} S\end{matrix} \qquad ( 1 )$$

The first item of Cₚ denotes the join probing costs; the second the cross-purge cost; the third the routing cost; and the fourth the selection cost. The routing cost is the same as the selection cost since each of them perform one comparison per result tuple.

The selection pull-up approach suffers from unnecessary join probing costs. With strong differences of the windows the situation deteriorates, especially when the selection is used in continuous queries with large windows. In such cases, the states may hold tuples unnecessarily long and thus waste huge amounts of memory. Another shortcoming for the selection pull-up sharing strategy is the routing cost of each joined result. The routing cost is proportional to the join selectivity S. This cost is also related to the fanout of the router operator, which corresponds to the number of queries the router serves. A router having a large fanout could be implemented as a range join between the joined tuple stream and a static profile table, with each entry holding a window size. Then the routing cost is proportional to the fanout of the router, which may be much larger than one.

3.2. Stream Partition with Selection Push-down. To avoid unnecessary join computations in the shared query plan using selection pull-up, we employ the selection push-down approach. Selection push-down can be achieved using multiple join operators, each processing part of the input data streams. We then need a split operator to partition the input stream A by the condition in the σ₄ operator. Thus, the stream A into different join operators are disjoint. We also need an order-preserving (on tuple timestamps) union operator to merge the joined results coming from the multiple joins. Such sharing paradigm applied to Q₁ and Q₂ will result in the shared query plan as shown by the diagram 30 in FIG. 3. The compare operation happens during the splitting of the streams, the merging of the tuples in the union operator, the routing step of the router and the probing of the joins. We can calculate the state memory consumption Cₘ and the CPU cost Cₚ for the selection push-down paradigm as:

$$\{ \begin{matrix}{C}_{m} = ( 2 - {s}_{σ} ) λ {W}_{1} {M}_{t} + ( 1 + {S}_{σ} ) λ {W}_{2} {M}_{t} \\ {C}_{p} = λ + 2 ( 1 - {S}_{σ} ) {λ}^{2} {W}_{1} + 2 S {σλ}^{2} {W}_{2} + \\ 3 λ + 2 {S}_{σ} {λ}^{2} {W}_{2} {S}_{} + 2 {λ}^{2} {W}_{1} {S}_{}\end{matrix} \qquad ( 2 )$$

The first item of Cₘ refers to the state memory in operator [symbol] ; the second the state memory in operator [symbol] . The first item of Cₚ corresponds to the splitting cost; the second to the join probing cost of [symbol] ; the third to the join probing cost of [symbol] ; the fourth to the cross-purge cost; the fifth to the routing cost; the sixth to the union cost. Since the outputs of [symbol] and [symbol] are sorted, the union cost corresponds to a one-time merge sort on timestamps.

Different from the sharing of identical file scans for multiple join operators, the state memory B₁ cannot be saved since B₂ may not contain B₁ at all times. The reason is that the sliding windows of B₁ and B₂ may not move forward simultaneously, unless the DSMS employs a synchronized operator scheduling strategy. Stream sharing with selection push-down tends to require much more joins (mn, m and n are the number of partitions of stream A and B respectively) than the naive sharing. With the asynchronous nature of these joins as discussed above, extra memory is consumed for the state memory. Such memory waste might be significant.

Obviously, the CPU cost Cₚ of a shared query plan generated by the selection push-down sharing is much smaller than the CPU cost of using the naive sharing with selection pull-up. However this sharing strategy still suffers from similar routing costs as the selection pull-up approach. Such cost can be significant, as already discussed for the selection pull-up case.

As discussed above, existing techniques for sharing window join queries suffer from one or more of the following cost factors: (1) expensive routing step; (2) state memory waste among asynchronous parallel joins; and (3) unnecessary join probings without selection push-down. Accordingly, there is a need for a method for sharing window queries that overcomes the disadvantages of existing techniques.

### SUMMARY OF THE INVENTION

The present invention is directed to a novel method for sharing window join queries. The invention teaches that window states of a join operator are sliced into fine-grained window slices and a chain of sliced window joins are formed. By using an elaborate pipelining methodology, the number of joins after state slicing is reduced from quadratic to linear. The inventive sharing enables pushing selections down into the chain and flexibly select subsequences of such sliced window joins for computation sharing among queries with different window sizes. Based on the inventive state-slice sharing process, two process sequences are proposed for the chain buildup. One minimizes the memory consumption while the other minimizes the CPU usage. The sequences are proven to find the optimal chain with respect to memory or CPU usage for a given query workload.

In accordance with an aspect of the invention, a method for sharing window-based joins includes slicing window states of a join operator into smaller window slices, forming a chain of sliced window joins from the smaller window slices, and reducing by pipelining a number of the sliced window joins. The method further includes pushing selections down into chain of sliced window joins for computation sharing among queries with different window sizes. The chain buildup of the sliced window joins includes finding a chain of the sliced window joins with respect to one of memory usage or processing usage.

In another aspect of the invention, a method includes slicing window states of a shared join operator into smaller pieces based on window constraints of individual queries, forming multiple sliced window joins with each joining a distinct pair of sliced window states, and pushing down selections into any one of the formed multiple sliced window joins responsive to computation considerations. The method further includes applying pipelining to the smaller pieces after the slicing for reducing sliced window joins to have a linear number of said multiple window sliced joins. A sequence of the multiple sliced window joins are selectively among queries with different window constraints. The pushing down of selections takes into account memory or processor usage.

In a yet further aspect of the invention, a method includes slicing a sliding window join into a chain of pipelined sliced joins for a chain buildup of the sliced joins in response to at least one of memory or processor considerations.

### BRIEF DESCRIPTION OF DRAWINGS

These and other advantages of the invention will be apparent to those of ordinary skill in the art by reference to the following detailed description and the accompanying drawings.

FIG. 1 is a block diagram of Query plans Q₁ and Q₂ to illustrate pior art sharing of continuous queries;

FIG. 2 is a block diagram of a known selection pull-up technique for sharing continuous query plans containing joins and selections applied to the sharing of joins with different window sizes;

FIG. 3 is a block diagram of known selection pull-up technique for sharing continuous query plans containing joins and selections applied to the sharing of joins with different window sizes;

FIG. 4 is a block diagram of a sliced one-way window join in accordance with the principles of the invention;

FIG. 5 is a chart of the execution steps to be followed for the sliced window join in accordance with the diagram of FIG. 4;

FIG. 6 is a block diagram of a chain of 1-way sliced window joins in accordance with the principles of the invention;

FIG. 7 is a block diagram of a chain of binary sliced window joins in accordance with the principles of the invention;

FIG. 8 is a chart of the execution steps to be followed for the binary sliced window join in accordance with the diagram of FIG. 7;

FIG. 9 is a block diagram of state-slice sharing in accordance with the principles of the invention;

FIG. 10 is a block diagram of memory-optimal state-slice sharing in accordance with the principles of the invention;

FIG. 11 is a block diagram depicting the merging of two sliced joins;

FIG. 12 is a diagram representing state-slice sharing in accordance with the principles of the invention; and

FIG. 13 is a block diagram of selection push-down for memory optimal state slice sharing in accordance with the principles of the invention.

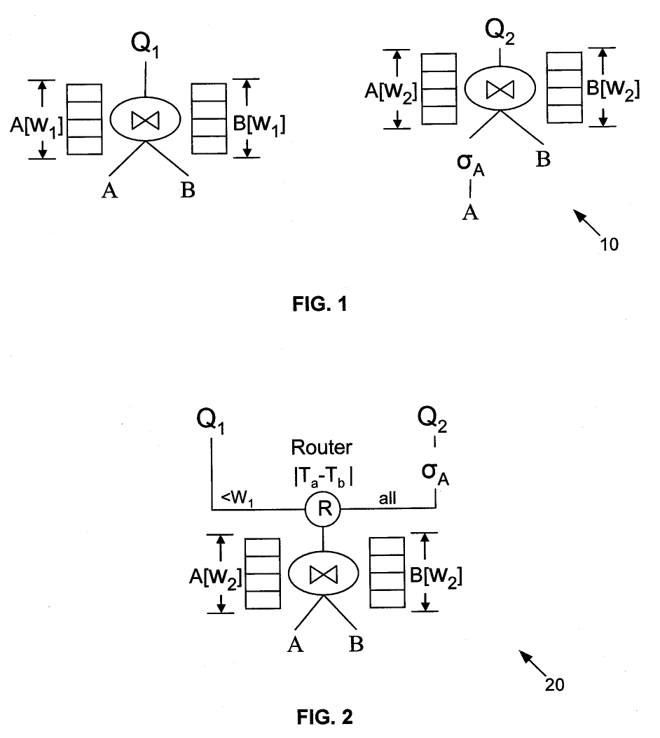

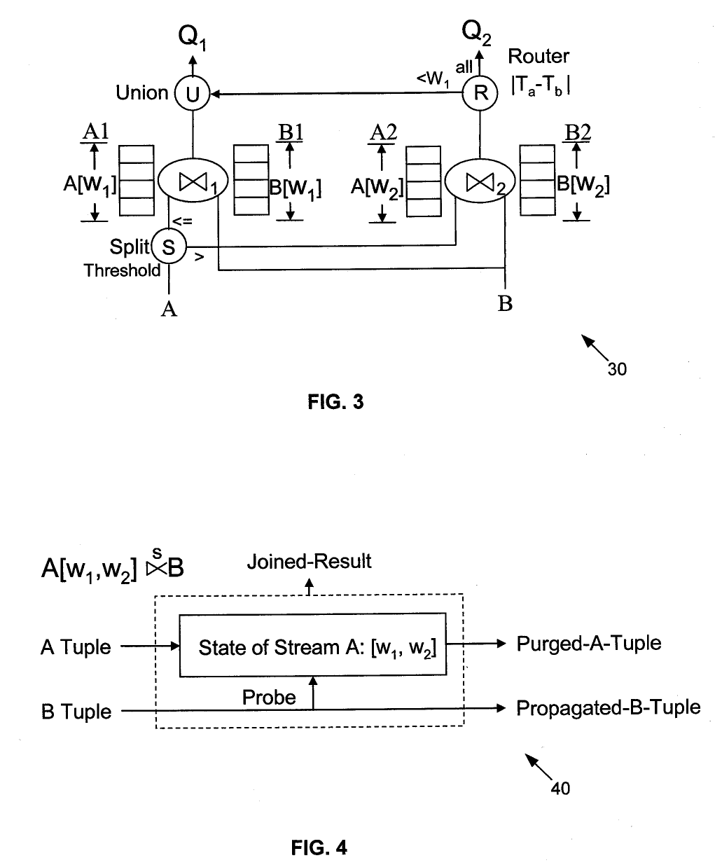

### DETAILED DESCRIPTION

To efficiently share computations of window-based join operators, the invention is a new method for sharing join queries with different window constraints and filters. The two key ideas of the invention are: state-slicing and pipelining. The window states of the shared join operator are sliced into fine-grained pieces based on the window constraints of individual queries. Multiple sliced window join operators, with each joining a distinct pair of sliced window states, can be formed. Selections now can be pushed down below any of the sliced window joins to avoid unnecessary computation and memory usage shown above. However, N² joins appear to be needed to provide a complete answer if each of the window states were to be sliced into N pieces. The number of distinct join operators needed would then be too large for a data stream management system DSMS to hold for a large N. We This hurdle is overcome by elegantly pipelining the slices. This enables building a chain of only N sliced window joins to compute the complete join result. This also enables to selectively share a subsequence of such a chain of sliced window join operators among queries with different window constraints.

Based on the inventive state-slice sharing, two algorithms are proposed for the chain buildup, one that minimizes the memory consumption and the other that minimizes the CPU usage. The algorithms are guaranteed to always find the optimal chain with respect to either memory or CPU cost, for a given query workload. Experimental results show that the invention provides the best performance over a diverse range of workload settings among alternate solutions in the literature.

State-Sliced One-Way Window Join

For purposes of the ensuing description, the following equivalent join operator notations are used: [symbol] is equivalent to |x, [symbol] is equivalent to x|, [symbol] is

equivalent to

$$\vert {\times }^{s} ,$$

is equivalent to

$${\times }^{s} \vert ,$$

is equivalent to

$${\times }^{s}$$

, and [symbol] is equivalent to x.

A one-way sliding window join of streams A and B is denoted as A[W]|ₓB

$$( or B {\times }^{s} \vert A [ W ] ) ,$$

where stream A has a sliding window of size W. The output of the join consists of all pairs of tuples a ε A, b ε B, such that T_{b}−Tₐ<W, and tuple pair (a,b) satisfies the join condition.
Definition 1. A sliced one-way window join on streams A and B is denoted as

$$A [ {W}^{start} , {W}^{end} ] \vert {\times }^{s} B ( or B {\times }^{s} \vert A [ {W}^{start} , {W}^{end} ] ) ,$$

where stream A has a sliding window of range: W^{end}−W^{start}. The start and end window are W^{start} and W^{end} respectively. The output of the join consists of all pairs of tuples a ε A, b ε B, such that W^{start}≦T_{b}−Tₐ<W^{end}, and (a,b) satisfies the join condition.

We can consider the sliced one-way sliding window join as a generalized form of the regular one-way window join. That is

$$A [ W ] \vert {\times }^{s} B = A [ 0 , W ] \vert {\times }^{s} B .$$

The diagram 40 FIG. 4 shows an example of a sliced one-way window join in accordance with the invention. This join has one output queue for the joined results, two output queues (optional) for purged A tuples and propagated B tuples. These purged tuples will be used by another sliced window join as input streams, which will be explained further below. The execution steps to be followed for the sliced window join

$$A [ {W}^{start} , {W}^{end} ] \vert {\times }^{s} B$$

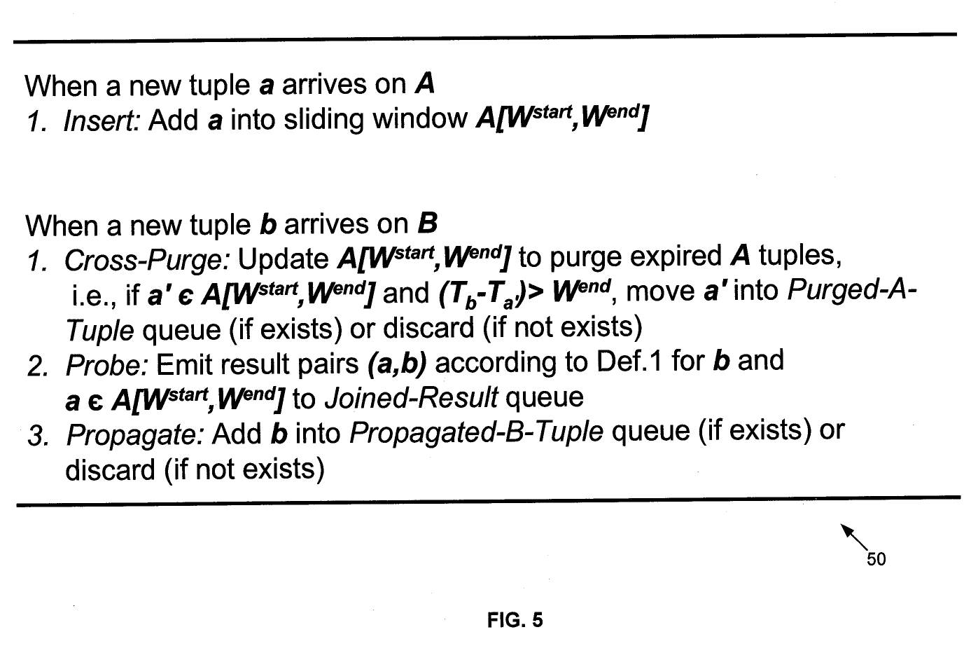

are shown by the diagram 50 in FIG. 5.

The semantics of the state-sliced window join require the checking of both the upper and lower bounds of the time-stamps in every tuple probing step. In FIG. 5, the newly arriving tuple b will first purge the state of stream A with W^{end}, before probing is attempted. Then the probing can be conducted without checking of the upper bound of the window constraint W^{end}. The checking of the lower bound of the window W^{end} can also be omitted in the probing since we use the sliced window join operators in a pipelining chain manner, as discussed below.
Definition 2. A chain of sliced one-way window joins is a sequence of pipelined N sliced one-way window joins, denoted as

$$A [ 0 , {W}_{1} ] \vert {\times }^{s} B , \\ A [ {W}_{1} , {W}_{2} ] \vert {\times }^{s} B , … , A [ {W}_{N - 1} , {W}_{N} ] \vert {\times }^{s} B .$$

The start window of the first join in a chain is 0. For any adjacent two joins, Jᵢ and Jᵢ₊₁, the start window of Jᵢ₊₁ equals the end window of prior Jᵢ (0≦i<N) in the chain. Jᵢ and Jᵢ₊₁ are connected by both the Purged-A-Tuple output queue of Jᵢ as the input A stream of Jᵢ₊₁, and the Propagated-B-Tuple output queue of Jᵢ as the input B stream of Jᵢ₊₁.

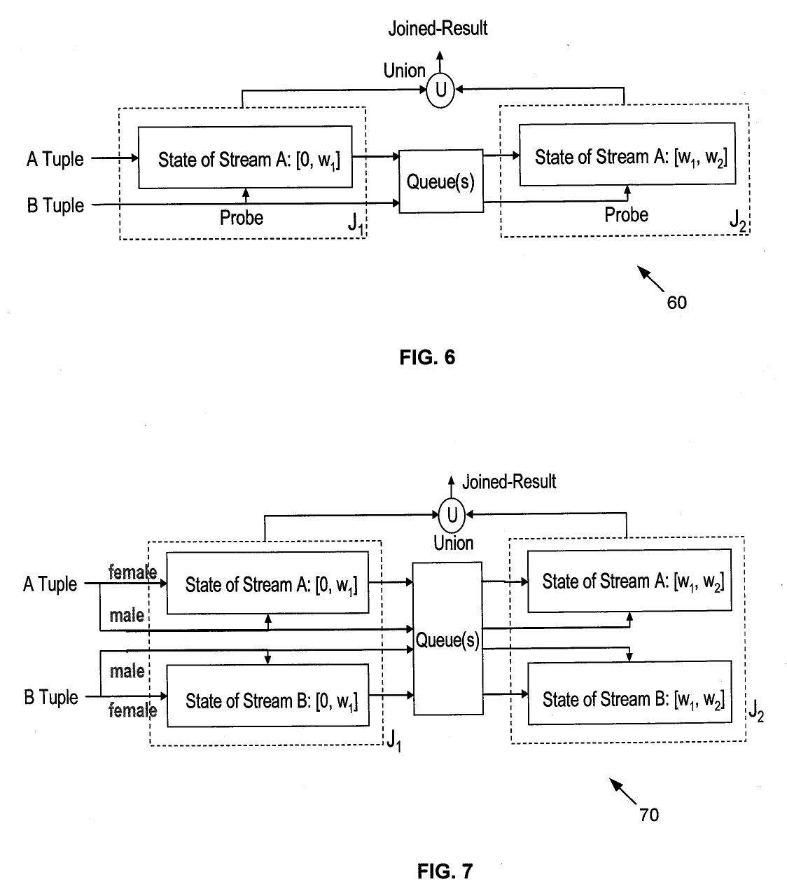

The diagram 60 of FIG. 6 shows a chain of state-sliced window joins having two one-way joins J₁ and J₂. We assume the input stream tuples to J₂, no matter from stream A or from stream B, are processed strictly in the order of their global time-stamps. Thus we use one logical queue between J₁ and J₂. This does not prevent us from using physical queues for individual input streams.

Table 2 below depicts an example execution of this chain. We assume that one single tuple (an a or a b ) will only arrive at the start of each second, w₁=2 sec, w₂=4 sec and every a tuple will match every b tuple (Cartesian Product semantics). During every second, an operator will be selected to run. Each running of the operator will process one input tuple. The content of the states in J₁ and J₂, and the content in the queue between J₁ and J₂ after each running of the operator are shown in Table 2.

TABLE 2
Execution of the Chain: J₁, J₂.

| T | AIT | OP | A × [0, 2] | Queue | A × [2, 4] | Output |
|---|---|---|---|---|---|---|
| 1 | a₁ | J₁ | [a₁] | [ ] | [ ] | |
| 2 | a₂ | J₁ | [a₂, a₁] | [ ] | [ ] | |
| 3 | a₃ | J₁ | [a₃, a₂, a₁] | [ ] | [ ] | |
| 4 | b₁ | J₁ | [a₃, a₂] | [b₁, a₁] | [ ] | (a₂, b₁), |
| | | | | | | (a₃, b₁) |
| 5 | b₂ | J₁ | [a₃] | [b₂, a₂, b₁, a₁] | [ ] | (a₃, b₂) |
| 6 | | J₂ | [a₃] | [b₂, a₂, b₁] | [a₁] | |
| 7 | | J₂ | [a₃] | [b₂, a₂] | [a₁] | (a₁, b₁) |
| 8 | a₄ | J₁ | [a₄, a₃] | [b₂, a₂] | [a₁] | |
| 9 | | J₂ | [a₄] | [a₃, b₂] | [a₂, a₁] | |
| 10 | | J₂ | [a₄] | [a₃] | [a₂, a₁] | (a₁, b₂), |
| | | | | | | (a₂, b₂) |

Execution in Table 2 follows the steps in FIG. 5. For example at the 4th second, first a₁ will be purged out of J₁ and inserted into the queue by the arriving b₁, since T_{b}_{₁}−Tₐ_{₁}≧2 sec. Then b₁ will purge the state of J₁ and output the joined result. Lastly, b₁ is inserted into the queue.

We observe that the union of the join results of J₁:

$$A [ 0 , w 1 ] \vert {\times }^{s} B and {J}_{2} \text{:} A [ w 1 , w 2 ] \vert {\times }^{s} B$$

is equivalent to the results of a regular sliding window join:

$$A [ w 2 ] \vert {\times }^{s} B .$$

The order among the joined results is restored by the merge union operator. To prove that the chain of sliced joins provides the complete join answer, we first introduce the following lemma.
Lemma 1. For any sliced one-way sliding window join

$$A [ {W}_{i - 1} , {W}_{i} ] \vert {\times }^{s} B$$

in a chain, at the time that one b tuple finishes the cross-purge step, but not yet begins the probe step, we have: (1) ∀a ε A::[Wᵢ₋₁,Wᵢ] [symbol] Wᵢ₋₁≦T_{b}−Ta<Wᵢ; and (2) ∀a tuple in the input steam A, Wᵢ₋₁≦T_{b}−Ta<Wᵢ [symbol] a ε A::[Wᵢ₋₁,Wᵢ]. Here A::[Wᵢ₋₁,Wᵢ] denotes the state of stream A.

Proof: (1). In the cross-purge step (FIG. 6), the arriving b will purge any tuple a with T_{b}−Tₐ≧Wᵢ. Thus ∀aᵢ ε A::[Wᵢ₋₁,Wᵢ], T_{b}−Taᵢ<Wᵢ. For the first sliced window join in the chain, Wᵢ₋₁=0. We have 0≦T_{b}−Ta. For other joins in the chain, there must exist a tuple aₘ ε A::[Wᵢ₋₁,Wᵢ] that has the maximum timestamp among all the a tuples in A::[Wᵢ₋₁,Wᵢ]. Tuple aₘ must have been purged by b′ of stream B from the state of the previous join operator in the chain. If b′=b, then we have T_{b}−Tₐ_{ₘ}≧Wᵢ₋₁, since Wᵢ₋₁ is the upper window bound of the previous join operator. If b′≠b, then T_{b′}−Tₐ_{ₘ}>Wᵢ₋₁, since T_{b}>T_{b′}. We still have T_{b}−Tₐ_{ₘ}>Wᵢ₋₁. Since Tₐ_{ₘ}≧Tₐ_{ₖ}, for ∀aₖ ε A::[Wᵢ₋₁,Wᵢ], we have Wᵢ₋₁≦T_{b}−Taₖ, for ∀aₖ ε A::[Wᵢ₋₁,Wᵢ]).

(2We use a proof by contradiction. If a≠A::[Wᵢ₋₁,Wᵢ], then first we assume a ε A::[Wⱼ₋,Wⱼ],j<i. Given Wᵢ₋₁≦T_{b}−Tₐ, we know Wⱼ≦T_{b}−Tₐ. Then a cannot be inside the state A::[Wⱼ₋₁,Wⱼ]since a would have been purged by b when it is processed by the join operator

$$A [ {W}_{j - 1} , {W}_{j} ] \vert {\times }^{s} B .$$

We got a contradiction. Similarly a cannot be inside any state A::[Wₖ₋₁,Wₖ], k>i. pt]0pt1.3expt]1.3ex0pt
Theorem 1. The union of the join results of all the sliced one-way window joins in a chain

$$A [ 0 , {W}_{1} ] \vert {\times }^{s} B , … , A [ {W}_{N - 1} , {W}_{N} ] \vert {\times }^{s} B$$

is equivalent to the results of a regular one-way sliding window join A[W_{N}]|×B.

Proof: [symbol] Lemma 1(1) shows that the sliced joins in a chain will not generate a result tuple (a,b) with Tₐ−T_{b}>W. That is, ∀(a,b) ε Å_{1≦i≦N} A[Wᵢ₋₁,Wᵢ]|^{s}×B [symbol] (a,b) ε A[W]|×B. [symbol] We need to show:

$$∀ ( a , b ) ∈ A [ W ] \vert \times B ⇒ ∃ i , s . t . ( a , b ) ∈ A [ {W}_{i - 1} , {W}_{i} ] \vert {\times }^{s} B .$$

### Without loss of generality, ∀(a,b) ε A[W]|×B, there exists unique i, such that Wᵢ₋₁≦T_{b}−Tₐ<Wᵢ, since W₀≦T_{b}−Tₐ<W_{N}. We want to show that

$$( a , b ) ∈ A [ {W}_{i - 1} , {W}_{i} ] \vert {\times }^{s} B .$$

### The execution steps in FIG. 5 guarantee that the tuple b will be processed by

$$A [ {W}_{i - 1} , {W}_{i} ] \vert {\times }^{s} B$$

at a certain time. Lemma 1(2) shows that tuple a would be inside the state of A[Wᵢ₋₁,Wᵢ] at that same time. Then

$$( a , b ) ∈ A [ {W}_{i - 1} , {W}_{i} ] \vert {\times }^{s} B .$$

### Since i is unique, there is no duplicated probing between tuples a and b .

From Lemma 1, we see that the state of the regular one-way sliding window join A[W]|×B is distributed among different sliced one-way joins in a chain. These sliced states are disjoint with each other in the chain, since the tuples in the state are purged from the state of the previous join. This property is independent from operator scheduling, be it synchronous or even asynchronous.

State-Sliced Binary Window Join

Similar to Definition 1, we can define the binary sliding window join. The definition of the chain of sliced binary joins is similar to Definition 2 and is thus omitted for space reasons. The diagram 70 of FIG. 7 shows an example of a chain of state-sliced binary window joins.
Definition 3. A sliced binary window join of streams A and B is denoted as

$$A [ {W}_{A}^{start} , {W}_{A}^{end} ] {\times }^{s} B [ {W}_{B}^{start} , {W}_{B}^{end} ] ,$$

where stream A has a sliding window of range: W_{A}^{end}−W_{A}^{start} and stream B has a window of range W_{B}^{end}−W_{B}^{start}. The join result consists of all pairs of tuples a ε A, b ε B, such that either W_{A}^{start}≦T_{b}−Tₐ<W_{A}^{end} or W_{B}^{start}≦Tₐ−T_{b}<W_{B}^{end}, and (a,b) satisfies the join condition.

The execution steps for sliced binary window joins can be viewed as a combination of two one-way sliced window joins. Each input tuple from stream A or B will be captured as two reference copies, before the tuple is processed by the first binary sliced window join¹. The copies can be made by the first binary sliced join. One reference is annotated as the male tuple (denoted as a^{m}) and the other as the female tuple (denoted as a^{f}). The execution steps to be followed for the processing of a stream A tuple by

$$A [ {W}^{start} , {W}^{end} ] {\times }^{s} B [ {W}^{start} , {W}^{end} ]$$

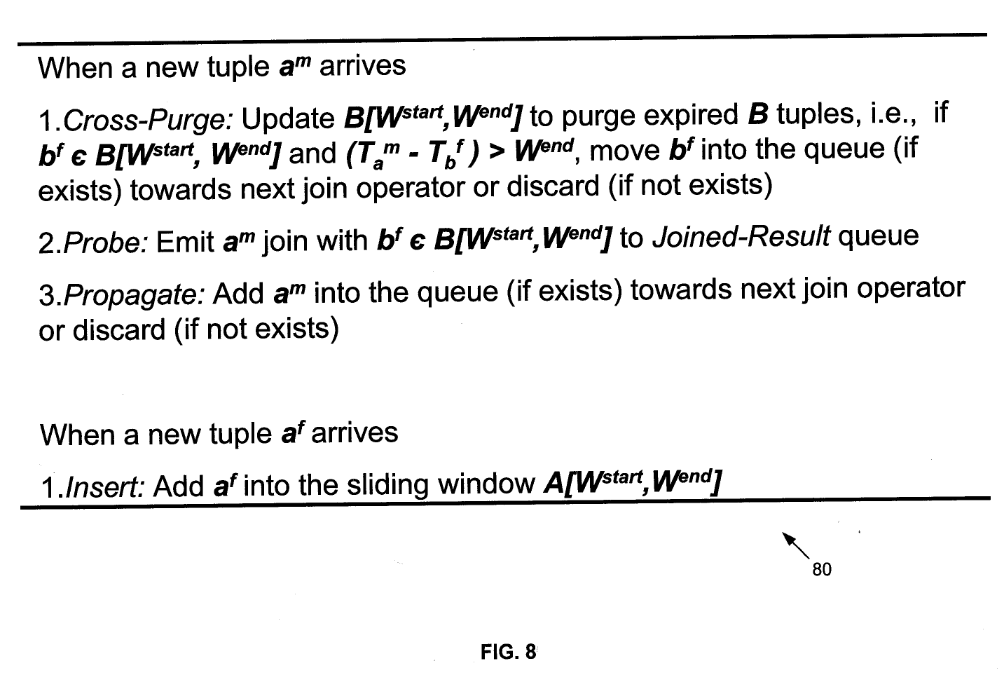

are shown by the diagram 80 of FIG. 8. The execution procedure for the tuples arriving from stream B can be similarly defined. ¹The copies can be made by the first binary sliced join.

Intuitively the male tuples of stream B and female tuples of stream A are used to generate join tuples equivalent to a one-way join:

$$A [ {W}^{start} , {W}^{end} ] \vert {\times }^{s} B .$$

The male tuples of stream A and female tuples of stream B are used to generate join tuples equivalent to the other one-way join:

$$A {\times }^{s} \vert B [ {W}^{start} , {W}^{end} ] .$$

Note that using two copies of a tuple will not require doubled system resources since: (1) the combined workload (in FIG. 8) to process a pair of female and male tuples equals the processing of one tuple in a regular join operator, since one tuple takes care of purging/probing and the other filling up the states; (2) the state of the binary sliced window join will only hold the female tuple; and (3) assuming a simplified queue (M/M/1), doubled arrival rate (from the two copies) and doubled service rate (from above (1)) still would not change the average queue size, if the system is stable. In our implementation, we use a copy-of-reference instead of a copy-of-object, aiming to reduce the potential extra queue memory during bursts of arrivals. Discussion of scheduling strategies and their effects on queues is beyond the scope of this paper.
Theorem 2. The union of the join results of the sliced binary window joins in a chain

$$A [ 0 , {W}_{1} ] {\times }^{s} B [ 0 , {W}_{1} ] , … , A [ {W}_{N - 1} , {W}_{N} ] {\times }^{s} B [ {W}_{N - 1} , {W}_{N} ]$$

is equivalent to the results of a regular sliding window join A[W_{N}]×B[W_{N}].

Using Theorem 1, we can prove Theorem 2. Since we can treat a binary sliced window join as two parallel one-way sliced window joins, the proof is fairly straightforward.

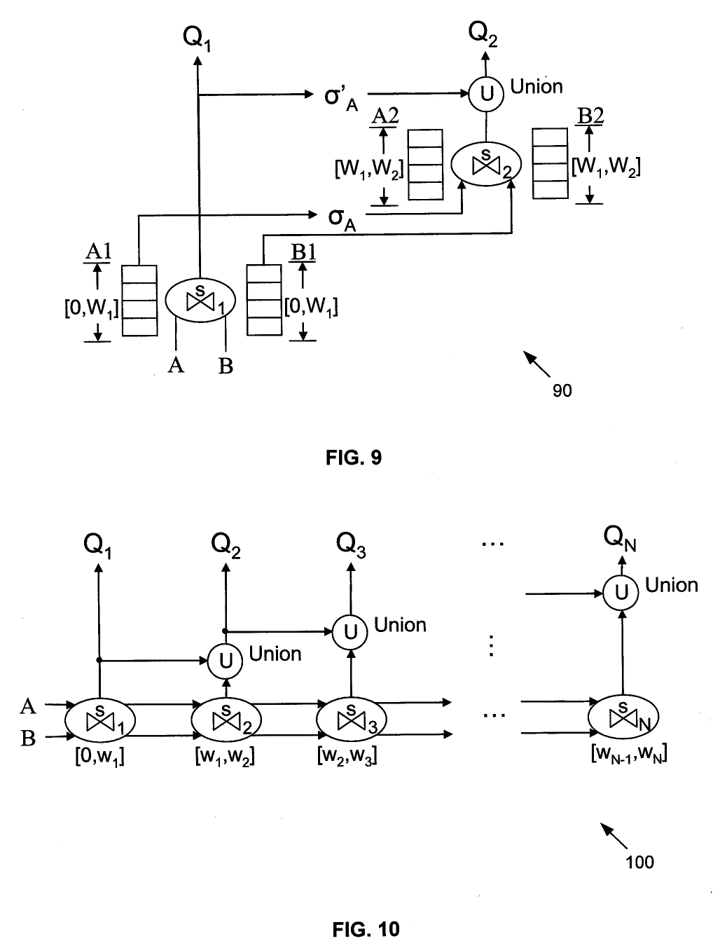

We now show how the proposed state-slice sharing can be applied to the running example introduced above to share the computation between the two queries. The shared plan is depicted by the diagram 90 of FIG. 9. This shared query plan includes a chain of two sliced sliding window join operators [symbol] and [symbol] The purged tuples from the states of [symbol] are sent to [symbol] as input tuples. The selection operator σ₄ filters the input stream A tuples for [symbol] The selection operator σ_{A} filters the joined results of [symbol] for Q₂. The predicates in σ_{A} and σ_{A} are both A.value>Threshold.

Compared to alternative sharing approaches discussed in the background of the invention section, the inventive state-slice sharing method offers significant advantages. Selection can be pushed down into the middle of the join chain. Thus unnecessary probings in the join operators are avoided. The routing cost is saved. Instead a pre-determined route is embedded in the query plan. States of the sliced window joins in a chain are disjoint with each other. Thus no state memory is wasted.

Using the same settings as previously, we now calculate the state memory consumption Cₘ and the CPU cost Cₚ for the state-slice sharing paradigm as follows:

$$\{ \begin{matrix}{C}_{m} = & 2 λ {W}_{1} {M}_{t} + ( 1 - {S}_{σ} ) λ ( {W}_{2} - {W}_{1} ) {M}_{t} \\ {C}_{p} = & 2 {λ}^{2} {W}_{1} + λ + 2 {λ}^{2} {S}_{σ} ( {W}_{2} - {W}_{1} ) + \\ & 4 λ + 2 λ + 2 {λ}^{2} {S}_{W 1}\end{matrix} \qquad ( 3 )$$

The first item of Cₘ corresponds to the state memory in [symbol] ; the second to the state memory in [symbol] . The first item of Cₚ is the join probing cost of [symbol] ; the second the filter cost of σ_{A}; the third the join probing cost of [symbol] ; the fourth the cross-purge cost; while the fifth the union cost; the sixth the filter cost of σ_{A}. The union cost in Cₚ is proportional to the input rates of streams A and B. The reason is that the male tuple of the last sliced join [symbol] acts as punctuation for the union operator. For example, the male tuple a₁^{f} is sent to the union operator after it finishes probing the state of stream B in [symbol] , indicating that no more joined tuples with timestamps smaller than a₁^{f} will be generated in the future. Such punctuations are used by the union operator for the sorting of joined tuples from multiple join operators.

Comparing the memory and CPU costs for the different sharing solutions, namely naive sharing with selection pull-up (Eq. 1), stream partition with selection push-down (Eq. 2) and state-slice chain (Eq. 3), the savings of using the state slicing sharing are:

$$\{ \begin{matrix}\frac{\frac{{C}_{m}^{( 1 )} + {C}_{m}^{( 3 )}}{{C}_{m}^{( 1 )}} = ( 1 - ρ ) ( 1 - {S}_{σ} )}{2} \\ \frac{{C}_{m}^{( 2 )} - {C}_{m}^{( 3 )}}{{C}_{m}^{( 2 )}} = ρ 1 + 2 ρ + ( 1 - ρ ) {S}_{σ} \\ \frac{{C}_{p}^{( 1 )} - {C}_{p}^{( 3 )}}{{C}_{p}^{( 1 )}} = ( 1 - ρ ) ( 1 - {S}_{σ} ) + ( 2 - ρ ) S 1 + 2 S \\ \frac{{C}_{p}^{( 2 )} - {C}_{p}^{( 3 )}}{{C}_{p}^{( 2 )}} = {S}_{σ} S ρ ( 1 - {S}_{σ} ) + {S}_{σ} + {S}_{σ} S + ρ S\end{matrix} \qquad ( 4 )$$

with Cₘ⁽ⁱ⁾ denoting Cₘ, Cₚ⁽¹⁾ denoting Cₚ in Equation i (i=1,2,3); and window ratio

$$ρ = \frac{{W}_{1}}{{W}_{2}} , 0 < ρ < 1.$$

Compared to sharing alternatives discussed in the background section above, the inventive state-slice sharing achieves significant savings. As a base case, when there is no selection in the query plans (i.e., S₉₄ =1), state-slice sharing will consume the same amount of memory as the selection pullup while the CPU saving is proportional to the join selectivity S. When selection exists, state-slice sharing can save about 20%-30% memory, 10%-40% CPU over the alternatives on average. For the extreme settings, the memory savings can reach about 50% and the CPU savings about 100%. The actual savings are sensitive to these parameters. Moreover, from Eq. 4 we can see that all the savings are positive. This means that the state-sliced sharing paradigm achieves the lowest memory and CPU costs under all these settings. Note that we omit λ in Eq. 4 for CPU cost comparison, since its effect is small when the number of queries is only 2. The CPU savings will increase with increasing λ, especially when the number of queries is large.

Turning now to the consideration of how to build an optimal shared query plan with a chain of sliced window joins. Consider a data stream management system DSMS with N registered continuous queries, where each query performs a sliding window join A[wᵢ]B[wᵢ] (1≦i≦N) over data streams A and B. The shared query plan is a DAG with multiple roots, one for each of the queries.

Given a set of continuous queries, the queries are first sorted by their window lengths in ascending order. Two processes are proosed for building the state-slicing chain in that order memory-optimal state-slicing and CPU-optimal state-slicing. The choice between them depends on the availability of the CPU and memory in the system. The chain can also first be built using one of the algorithms and migrated towards the other by merging or splitting the slices at runtime.

Memory-Optimal State-Slicing

Without loss of generality, we assume that wᵢ<wᵢ₊₁ (1≦i<N). Let's consider a chain of the N sliced joins: J₁, J₂, . . . , J_{N}, with Jᵢ as

$$A [ {w}_{i - 1} , {w}_{i} ] \begin{matrix}{ }^{s} \\ \end{matrix} B [ {w}_{i - 1} , {w}_{i} ]$$

(1≦i≦N, w₀=0). A union operator Uᵢ is added to collect joined results from J₁, . . . , Jᵢ for query Qᵢ (1<i≦N), as shown by diagram 100 of FIG. 10. We call this chain the memory-optimal state-slice sharing (Mem-Opt). The correctness of Mem-Opt state-slice sharing is proven in Theorem 3 by using Theorem 2. We have the following equivalence for i (1≦i≦N):

$${Q}_{i} \text{:} A [ {w}_{i} ] B [ {w}_{i} ] = {⋃}_{1 \leq j \leq i} A [ {W}_{j - 1} , {W}_{j} ] \begin{matrix}{ }^{s} \\ \end{matrix} B [ {W}_{j - 1} , {W}_{j} ]$$

Theorem 3. The total state memory used by a Mem-Opt chain of sliced joins J₁, J₂, . . . , J_{N}, with Jᵢ as

$$A [ {w}_{i - 1} , {w}_{i} ] \begin{matrix}{ }^{s} \\ \end{matrix} B [ {w}_{i - 1} , {w}_{i} ] \qquad ( 1 \leq i \leq N , {w}_{0} = 0 )$$

is equal to the state memory used by the regular sliding window join: A[w_{N}]B[w_{N}].
Proof: From Lemma 1, the maximum timestamp difference of tuples (e.g., A tuples) in the state of Jᵢ is (wᵢ−wᵢ₋₁), when continuous tuples from the other stream (e.g., B tuples) are processed. Assume the arrival rate of streams A and B is denoted by λ_{A} and λ_{B} respectively. Then we have:

$$\begin{matrix}1 \leq i \leq N \sum {Mem}_{{J}_{i}} = ( {λ}_{A} + {λ}_{B} ) [ ( {w}_{1} - {w}_{0} ) + ( {w}_{2} - {w}_{1} ) + … + ( {w}_{N} - {w}_{N - 1} ) ] \\ = ( {λ}_{A} + {λ}_{B} ) {w}_{N}\end{matrix}$$

### Where (λ_{A}+λ_{B})w_{N} is the minimal amount of state memory that is required to generate the full joined result for Q_{N}. Thus the Mem-Opt chain consumes the minimal state memory.

Let's again use the count of comparisons per time unit as the metric for estimated CPU costs. Comparing the execution (FIG. 8) of a sliced window join with the execution (table 1) of a regular window join, we notice that the probing cost of the chain of sliced joins: J₁, J₂, . . . , J_{N} is equivalent to the probing cost of the regular window join: A[w_{N}]B[w_{N}].

Comparing to the alternative sharing methods noted above in the Background of the Invention, we notice that the Memory-Optimal chain may not always win since it requires CPU cost for: (1) (N−1) more times of purging for each tuple in the streams A and B; (2) extra system overhead for running more operators; and (3) CPU cost for (N−1) union operators. In the case that the selectivity of the join S is rather small, the routing cost in the selection pull-up sharing may be less than the extra cost of the Mem-Opt chain. In short, the Mem-Opt chain may not be the CPU-optimal solution for all settings.

CPU-Optimal State-Slicing

We hence now discuss how to find the CPU-Optimal state-slice sharing (CPU-Opt) which will yield minimal CPU costs. We notice that the Mem-Opt state-slice sharing may result in a large number of sliced joins with very small window ranges each. In such cases, the extra per tuple purge cost and the system overhead for holding more operators may not be capable of being neglected.

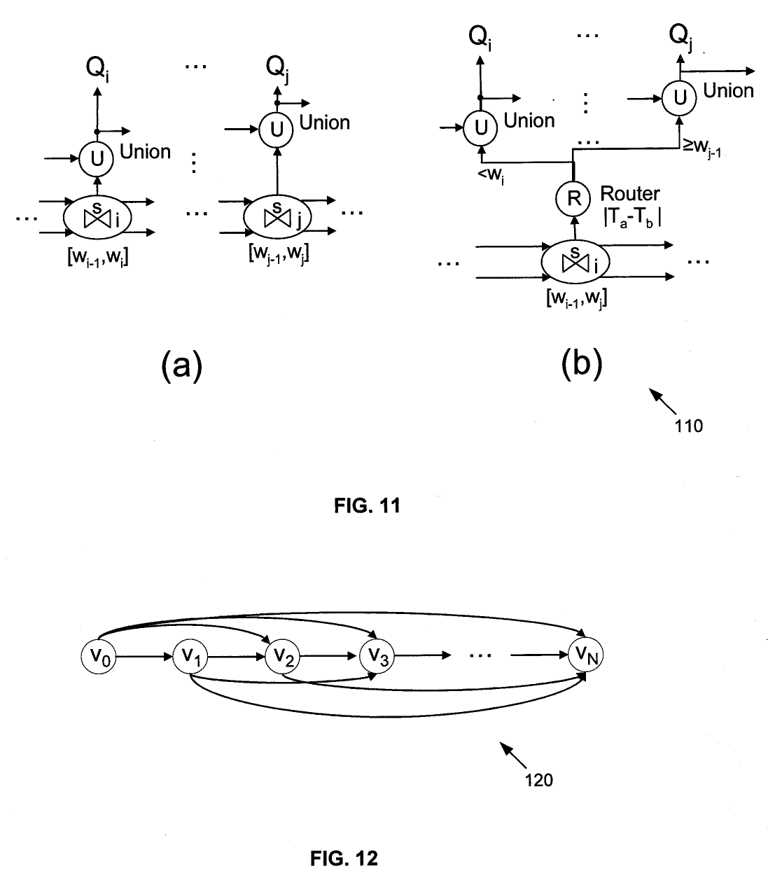

In FIG. 11(b), diagram 110, the state-sliced joins from Jᵢ to Jⱼ are merged into a larger sliced join with the window range being the summation of the window ranges of Jᵢ and Jⱼ. A routing operator then is added to split the joined results to the associated queries. Such merging of concatenated sliced joins can be done iteratively until all the sliced joins are merged together. In the extreme case, the totally merged join results in a shared query plan, which is equal to that formed by using the selection pull-up sharing method shown in Section 3. The CPU cost may decrease after the merging.

Both the shared query plans in FIG. 11 have the same join probing costs and union costs. Using the symbols defined in Section 3 and C_{sys} denoting the system overhead factor, we can calculate the difference of partial CPU cost Cₚ^{(a)} in FIG. 5.2 and Cₚ^{(b)} in FIG. 11(b) as:

$${C}_{p}^{( a )} - {C}_{p}^{( b )} = ( {λ}_{A} + {λ}_{B} ) ( j - i ) - 2 {λ}_{A} {λ}_{B} ( {w}_{j} - {w}_{i - 1} ) σ ( j - i ) + {C}_{sys} ( j - i + 1 ) ( {λ}_{A} + {λ}_{B} )$$

The difference of CPU costs in these scenarios comes from the purge cost (the first item), the routing cost (the second item) and the system overhead (the third item). The system overhead mainly includes the cost for moving tuples in/out of the queues and the context change cost of operator scheduling. The system overhead is proportional to the data input rates and number of operators.

Considering a chain of N sliced joins, all possible merging of sliced joins can be represented by edges in a directed graph G={V,E}, where V is a set of N+1 nodes and E is a set of

$$\frac{N ( N + 1 )}{2}$$

edges. Let ∀vᵢ ε V(0≦i≦N) represent the window wᵢ of Qᵢ (w₀=0). Let the edge e_{i,j} from node vᵢ to node vⱼ (i<j) represent a sliced join with start-window as wᵢ and end-window as wⱼ. Then each path from the node v₀ to node v_{N} represents a variation of the merged state-slice sharing, as shown by the diagram 120 in FIG. 12.

Similar to the above calculation of Cₚ^{(a)} and Cₚ^{(b)}, we can calculate the CPU cost of the merged sliced window joins represented by every edge. We denote the CPU cost e_{i,j} of the sliced join as the length of the edge l_{i,j}. We have the following lemma.
Lemma 2. The calculations of CPU costs l_{i,j} and l_{m,n} are independent if 0≦i<j≦m<n≦N.

Based on Lemma 2, we can apply the principle of optimality here and transform the optimal state-slice problem to the problem of finding the shortest path from v₀ to v_{N} in an acyclic directed graph. Using the well-known Dijkstra 's algorithm, we can find the CPU-Opt query plan in O(N²), with N being the number of the distinct window constraints in the system. Even when we incorporate the calculation of the CPU cost of the

$$\frac{N ( N + 1 )}{2}$$

edges, the total time for getting the CPU optimal state-sliced sharing is still O(N²).

In case the queries do not have selections, the CPU-Opt chain will consume the same amount of memory as the Mem-Opt chain. With selections, the CPU-Opt chain may consume more memory.

Online Migration of the State-Slicing Chain

Online migration of the shared query plan is important for efficient processing of stream queries. The state-slicing chain may need maintenance when: (1) queries enter or leave the system, (2) queries update predicates or window constraints, and (3) runtime statistic collection invokes plan adaptation.

The chain migration is achieved by two primitive operation: merging and splitting of the sliced join. For example when query Qᵢ (i<N) leaves the system, the corresponding sliced join

$$A [ {w}_{i - 1} , {w}_{i} ] \begin{matrix}{ }^{s} \\ \end{matrix} B [ {w}_{i - 1} , {w}_{i} ]$$

could be merged with the next sliced join in the chain. Or if the corresponding sliced join had been merged with others in the CPU-Opt chain, splitting of the merged join may be invoked first.

Online splitting of the sliced join Jᵢ can be achieved by: (1) stopping the system execution for Jᵢ; (2) updating the end window of Jᵢ to w′ᵢ; (3) inserting a new sliced join J′ᵢ with window [w′ᵢ,wᵢ] to the right of Jᵢ and connecting the query plan; and (4) resuming the system. The queue between Jᵢ and J′ᵢ is empty right after the insertion. The execution of Jᵢ will purge tuples, due to its new smaller window, into the queue between Jᵢ and J′ᵢ and eventually fill up the states of J′ᵢ correctly.

Online merging of two adjacent sliced joins Jᵢ and Jᵢ₊₁ requires the queues between these two joins empty. This can be achieved by scheduling the execution of Jᵢ₊₁ after stopping the scheduling of Jᵢ. Once the queue between Jᵢ and Jᵢ₊₁ is empty, we can simply (1) concatenate the corresponding states of Jᵢ and Jᵢ₊₁; (2) update the end window of Jᵢ to wᵢ₊₁; (3) remove Jᵢ₊₁ from the chain; and (4) resume the system.

The overhead for chain migration corresponds to constant system cost for operator insertion/deletion. The system suspending time during join splitting is neglectable, while during join merging it is bounded by the execution time needed to empty the queue in-between. No extra processing costs arise in either case.

Push Selections into Chain

When the N continuous queries each have selections on the input streams, we aim to push the selections down into the chain of sliced joins. For clarity of discussion, we focus on the selection push-down for predicates on one input stream. Predicates on multiple streams can be pushed down similarly. We denote the selection predicate on the input stream A of query Qᵢ as σᵢ and the condition of σᵢ as condᵢ.

Mem-Opt Chain with Selection Push-Down

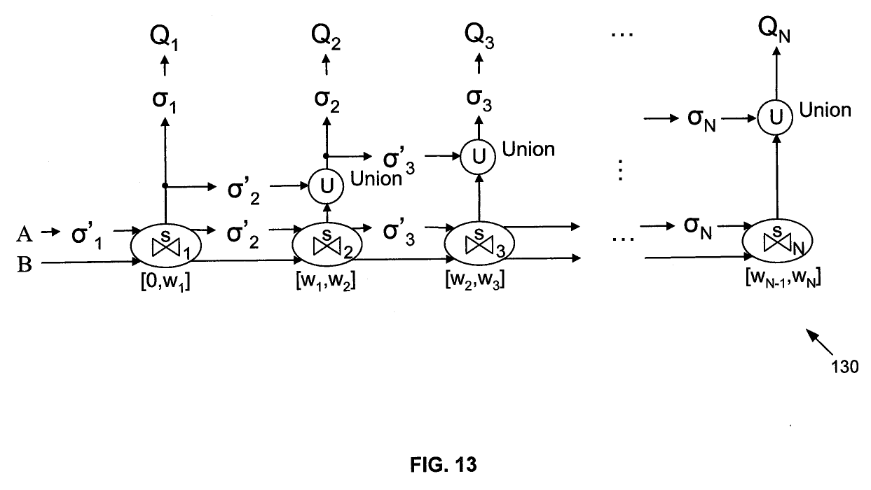

The selections can be pushed down into the chain of sliced joins as shown by the diagram 130 in FIG. 13. The predicate of the selection σ′ᵢ corresponds to the disjunction of the selection predicates from σᵢ to σ_{N}. That is:

cond′ᵢ=condᵢ v condᵢ₊₁ v . . . v cond_{N}

Logically each tuple may be evaluated against the same selection predicate for multiple times. In the actual execution, we can evaluate the predicates (cond₁, 1≦i≦N) in the decreasing order of i for each tuple. As soon as a predicate (e.g. condₖ) is satisfied, stop further evaluating and attach k to the tuple. Thus this tuple can survive until the k th slice join and no further. Similar to Theorem 3, we have the following theorem.
Theorem 4. The Mem-Opt state-slice sharing with selection push-down consumes the minimal state memory for a given workload.

Intuitively the total state memory consumption is minimal since that: (1) each join probe performed by [symbol] in FIG. 13 is required at least by one of the queries: Qᵢ, Qᵢ₊₁, . . . , Q_{N}; (2) any input tuple that won't contribute to the joined results will be filtered out immediately; and (3) the contents in the state memory of all sliced joins are pairwise disjoint with each other.

CPU-Opt Chain with Selection Push-Down

The merging of adjacent sliced joins with selection push-down can be achieved following the scheme shown in FIG. 11. Merging sliced joins having selection between them will cost extra state memory usage due to selection pull-up. The tuples, which would be filtered out by the selection before, will now stay unnecessarily long in the state memory. Also, the consequent join probing cost will increase accordingly. Continuous merging of the sliced joins will result in the selection pull-up sharing approach discussed in the background.

Similarly to the CPU optimization discussed above with respect to the CPU-optimal state-slicing, the Dijkstra's algorithm can be used to find the CPU-Opt sharing plan with minimized CPU cost in O(N²) Such CPU-Opt sharing plan may not be Memory-Optimal.

In summary, window-based joins are stateful operators that dominate the memory and CPU consumptions in a data stream management system DSMS. Efficient sharing of window-based joins is a key technique for achieving scalability of a DSMS with high query workloads. The invention is a new method for efficiently sharing of window-based continuous queries in a DSMS. By slicing a sliding window join into a chain of pipelining sliced joins, the inventive method results in a shared query plan supporting the selection push-down, without using an explosive number of operators. Based on the state-slice sharing, two algorithms are proposed for the chain buildup, which achieve either optimal memory consumption or optimal CPU usage.

The present invention has been shown and described in what are considered to be the most practical and preferred embodiments. The inventive state-slice method can be extended to distributed systems, because the properties of the pipelining sliced joins fit nicely in the asynchronous distributed system. Also, when the queries are too many to fit into memory, combining query indexing with state-slicing is a possibility. That departures may be made there from and that obvious modifications will be implemented by those skilled in the art. It will be appreciated that those skilled in the art will be able to devise numerous arrangements and variations which, although not explicitly shown or described herein, embody the principles of the invention and are within their spirit and scope.

What is claimed is:

1. A method comprising the steps of:
slicing window states of a join operator into smaller window slices,
forming a chain of sliced window joins from said smaller window slices, and
reducing by pipelining a number of said sliced window joins.

2. The method of claim 1, further wherein the step of reducing comprises building a chain of only linear of pipelines of said sliced window joins.

3. The method of claim 1, wherein said step of reducing a number of said sliced window joins comprises pipelining to reduce said number from quadratic to linear.

4. The method of claim 1, further comprising pushing selections down into said chain of sliced window joins for computation sharing among queries with different window sizes.

5. The method of claim 1, further comprising a chain buildup of said sliced window joins that minimizes memory consumption.

6. The method of claim 3, further comprising a chain buildup of said sliced window joins that minimizes processing usage.

7. The method of claim 3, further comprising a chain buildup of said sliced window joins to find a chain of said sliced window joins with respect to one of memory usage or processing usage.

8. A method comprising the steps of:
slicing window states of a shared join operator into smaller pieces based on window constraints of individual queries,
forming multiple sliced window joins with each joining a distinct pair of sliced window states, and
pushing down selections into any one of said formed multiple sliced window joins responsive to computation considerations.

9. The method of claim 8, further comprising applying pipelining to said smaller pieces after said slicing for reducing sliced window joins to have a linear number of said multiple window sliced joins.

10. The method of claim 8, wherein stream tuples go through said multiple window slice joins which compute a complete join result.

11. The method of claim 8, further comprising selectively sharing a sequence of said multiple sliced window joins among queries with different window constraints.

12. The method of claim 9, wherein said step of pushing down selections comprises memory usage consideration.

13. The method of claim 9, wherein said step of pushing down selections comprises processor usage.

14. The method of claim 9, wherein said step of pushing down selections comprises one of memory usage or processor usage.

15. A method comprising:
slicing a sliding window join into a chain of pipelined sliced joins for a chain buildup of said sliced joins in response to at least one of memory or processor considerations.
